(19) United States
(12) Patent Application Publication
(10) Pub. No.: US 2012/0153189 A1
(43) Pub. Date: Jun. 21, 2012

(54) OPTICAL SYSTEM FOR GENERATING A LIGHT BEAM FOR TREATING A SUBSTRATE

(75) Inventors: Johannes Wangler, Koenigsbronn (DE); Michael Layh, Aalen (DE); Markus Zenzinger, Ulm (DE); Holger Muenz, Aalen (DE)

(73) Assignee: CARL ZEISS LASER OPTICS GMBH, Oberkochen (DE)

(21) Appl. No.: 13/352,725

(22) Filed: Jan. 18, 2012

Related U.S. Application Data
(63) Continuation of application No. PCT/EP2010/060504, filed on Jul. 20, 2010.

(30) Foreign Application Priority Data
Jul. 31, 2009 (DE) 10 2009 037 112.5

(51) Int. Cl. B01J 19/12

(52) U.S. Cl. 250/492.1

(57) ABSTRACT

An optical system for generating a light beam for treating a substrate arranged in a substrate plane is disclosed. The optical system includes first and second optical arrangements.

### CROSS-REFERENCE TO RELATED APPLICATIONS

This application is a continuation of, and claims benefit under 35 USC 120 to, international application PCT/EP2010/060504, filed Jul. 20, 2010, which claims benefit under 35 USC 119 of German Application No. 10 2009 037 112.5, filed Jul. 31, 2009. International application PCT/EP2010/060504 is hereby incorporated by reference in its entirety.

### FIELD

The disclosure relates to an optical system for generating a light beam for treating a substrate arranged in a substrate plane. The light beam has a beam length in a first dimension perpendicular to the propagation direction of the light beam. The light beam has a beam width in a second dimension perpendicular to both the first dimension and the light propagation direction. The beam length is large relative to the beam width. The optical system includes a first optical arrangement which defines a plurality of light channels beside one another in the first dimension and which divide the light beam in the first dimension into a plurality of partial fields. The partial fields are incident in the substrate plane in a manner superimposed on one another in the first dimension.

### BACKGROUND

An optical system for generating a light beam for treating a substrate arranged in a substrate plane is known from WO 2006/066706 A2. An optical system for generating a light beam for treating a substrate arranged in a substrate plane is used for example for melting materials, in particular in the field of the light-induced crystallization of silicon. One specific application is flat screen production, in which substrates provided with an amorphous silicon layer are treated using a light beam in order to crystallize the silicon. In this case, the substrates used have relatively large dimensions, for example in the range of greater than 30 cm×greater than 50 cm. With this type an optical system, a light beam is accordingly generated which has a beam length in a first dimension (which is designated by X hereinafter), the beam length corresponding approximately to the width of the substrate (for example approximately 30 cm). In the dimension (designated by Y hereinafter) perpendicular to the X-dimension, the light beam is intended to be very thin. Beam widths in the Y-dimension of a few micrometers are desirable in order to obtain an energy density that is very high for the treatment of the substrate.

The light beam thus applied to the substrate accordingly has a large ratio of beam length in the X-dimension to beam width in the Y-dimension. This ratio can be greater than 5,000, even greater than 10,000, depending on the beam length.

The light beam used for treating the substrate generally has to satisfy substantially two desirable features. First, the intensity distribution of the light beam should be very homogeneous in the X-dimension, and in the Y-dimension the intensity distribution of the light beam should have a very great edge steepness.

Generally, homogeneity of the light beam in the (large) X-dimension has not yet been satisfactorily achieved. The optical system known from the document WO 2006/066706 A2 has an optical arrangement which defines a plurality of light channels beside one another in the first dimension and which divide the light beam in the first dimension into a plurality of partial fields that partly overlap in the first dimension. The partial fields are incident in the substrate plane in a manner superimposed on one another in the first dimension. In the known optical system, the optical arrangement that defines the light channels is embodied in the form of a fly's eye condenser having one or two elements. The fly's eye condenser is embodied as a cylindrical lens array, that is to say that a plurality of individual cylindrical lenses are arranged beside one another in the X-dimension. Each individual cylindrical lens defines a light channel. Upon passing through the plurality of light channels, the light beam is divided into a corresponding number of partial fields. Using a downstream condenser optical unit, the individual partial fields are then superimposed again in the X-dimension on the substrate, resulting in mixing and hence homogenizing of the intensity distribution of the light beam in the X-dimension.

In the case of the known optical system, the homogeneity of the intensity distribution in the X-dimension is not optimal. In the case of the known optical system, the light beam, usually a laser beam, having a dimension X_{L} in the first dimension and a dimension Y_{L} in the second dimension and a divergence Dₓ predetermined by the light source in the first dimension and a divergence D_{y} in the second dimension, impinges on the first optical arrangement in the form of the fly's eye condenser. In particular, interference effects and beat effects in the light beam on the substrate have been observed, which can impair the result of the treatment of the substrate using the light beam.

### SUMMARY

The disclosure provides an improved optical system for generating a light beam for treating a substrate arranged in a substrate plane. The optical system is intended to be able to generate a light beam for treating a substrate having a large beam length and a small beam width, the intensity distribution of which in the X-dimension has relatively high homogeneity.

A second optical arrangement is arranged upstream of the first optical arrangement in the light propagation direction. The second optical arrangement has an extent in the first dimension and widening an angular spectrum of the light beam incident on the second optical arrangement in the first dimension such that the etendue of the second optical arrangement in the first dimension is 50% to 100% of the total etendue of the optical system in the first dimension, so that approximately all of the light channels of the first optical arrangement are illuminated uniformly with light.

In the case of the optical system according to the disclosure, a second optical arrangement is disposed upstream of the first optical arrangement dividing the incident light beam into partial fields. The second optical arrangement preprocesses the light beam incident on the second optical arrangement so that the light beam is subsequently incident on the first optical arrangement with a widened angular spectrum and high extent in the first dimension. In the case of the optical system according to the disclosure, therefore, in contrast to the known optical system, the light beam is not incident in the individual light channels of the first optical arrangement with the predetermined natural divergence of the light beam, but rather with a divergence or aperture greatly increased by the second optical arrangement. In the case of the known optical system, the individual light channels of the first optical arrangement are only insufficiently filled with light, as a result of which interference and beat effects are caused in the substrate plane. In the case of the optical system according to the disclosure, by contrast, the individual light channels of the first optical arrangement are filled with light more uniformly on account of the previously widened angular spectrum of the incident light beam. In other words, the light beam enters into the first optical arrangement, which defines the light channels, in a prehomogenized fashion. The second optical arrangement thus brings about additional mixing of the light of the incident light beam, as a result of which the downstream first optical arrangement can homogenize the light beam even more effectively. With the second optical arrangement, preferably the entire etendue in the X-dimension is introduced, to be precise in a single stage, namely by the second optical arrangement. The intensity distribution of the light beam generated by the optical system according to the disclosure is therefore significantly more homogeneous in the substrate plane than in the case of the known optical system, as a result of which the result of the treatment of the substrate using the light beam is improved.

Etendue in the first dimension and total etendue in the first dimension are understood here to mean the one-dimensional etendue and, respectively, total etendue in the X-dimension. In this case, the etendue LLWₓ of the first optical arrangement is given by the equation: LLWₓ=Dₓ*NAₓ, where Dₓ is the extent of the first optical arrangement in the first dimension and NAₓ is the numerical aperture of the first optical arrangement in the first dimension.

In one preferred configuration, the etendue of the second optical arrangement is 70% to 100%, preferably 80% to 100%, with further preference 90% to 100%, of the total etendue of the optical system.

The higher the etendue introduced into the system by the second optical arrangement, the more homogeneous the intensity distribution of the linear light beam in the substrate plane.

In one preferred configuration, the optical properties of the second optical arrangement are designed such that light emerging from an arbitrary partial region of the second optical arrangement along the first dimension in each case at least approximately contains the entire angular information and approximately enters into each light channel of the first optical arrangement.

In this configuration, in other words, the first optical arrangement is completely illuminated with the aperture of the second optical arrangement by way of the size of the first optical arrangement. Accordingly, in the case of this configuration, each spatial mode of the light beam incident on the second optical arrangement is distributed over the entire first optical arrangement, i.e. the totality of the light channels defined thereby. “Partial region” should be understood here to mean a minimal region of the second optical arrangement with an extent in the first dimension, from which emerging light contains virtually the complete or the complete angular information. Such a partial region is usually also designated as “pitch”.

In a further preferred configuration, the second optical arrangement is designed to alter the beam width of the incident light beam in the second dimension via positional adjustment, in particular via rotation about the light propagation direction.

In this case, it is advantageous that the second optical arrangement not only contributes to homogenizing the light beam in the X-dimension, but also fulfils a second function, namely altering the beam width of the incident light beam in the second dimension. As a result, in the Y-dimension, too, it is possible to introduce a small etendue in a controlled manner and in one stage. The variability of the beam width of the incident light beam in the second dimension is desirable because the beam width is a parameter of the substrate-dependent treatment. The configuration mentioned above obviates additional optical arrangements for beam widening in Y, as described for example in WO 2006/066706 A2.

In a further preferred configuration, the second optical arrangement has at least one optical element having a structure having a scattering and/or diffracting effect one-dimensionally in the first dimension.

Such an optical element can be refractive or diffractive.

In one preferred configuration, the at least one optical element is a diffractive optical element.

Preferably, the structure having a scattering and/or diffracting effect has structure elements that form aperiodic partial structures, wherein each partial structure forms one of the abovementioned partial regions from which respectively emerging light at least approximately contains the entire angular information.

In this configuration, the at least one optical element of the second optical arrangement has aperiodic partial structures formed by individual structure elements. A plurality of structure elements that differ among one another with regard to distance and/or size (in the direction of the first dimension) respectively form a partial structure, wherein each individual partial structure forms a “pitch” or one of the abovementioned partial regions from which emerging light in each case contains the entire or virtually the entire angular information. By virtue of the aperiodicity of the partial structures among one another, periodic interferences which can be mixed away by the first optical arrangement only to a specific extent and could therefore lead to a residual modulation in the substrate plane are now advantageously avoided before the light beam actually enters into the first optical arrangement. This applies, in particular, to the case where the light channels of the first optical arrangement themselves have a more or less periodic structure.

In a further preferred configuration, distances between respectively adjacent partial structures and/or the size of the partial structures in the first dimension of the structure of the optical element having a scattering and/or diffracting effect are/is different.

In this configuration, the at least one optical element having a structure having a diffracting effect one-dimensionally in the first dimension can be embodied as a line grating in one very simple realization, wherein the line distance between the individual lines of the grating varies stochastically from line to line. A plurality of such lines then respectively forms a partial structure or a partial region which imparts the full angular information to the light individually in each case.

With regard to the abovementioned configuration according to which the second optical arrangement alters the beam width of the incident light beam in the second dimension by positional adjustment, a one-dimensional grating is particularly advantageous since, for increasing the beam width or for reducing the beam width in the second dimension, the grating, as is provided in a further preferred configuration, merely has to be mounted in the optical system in a manner rotatable about the axis of the light propagation direction. As soon as the lines of the one-dimensional grating are rotated from a 0° position, in which the lines of the grating run perpendicularly to the X-dimension, the grating also has a diffracting effect in the Y-direction, as a result of which the beam width in the Y-dimension is increased. In this way, with the one-directional grating, in the Y-direction, from a Gaussian intensity distribution, it is possible to set a wider top-hat-type intensity distribution (i.e. intensity distribution having a flat plateau and high edge steepness) with a corresponding beam width in the Y-dimension.

In a further preferred configuration, an average distance of the distances between respectively adjacent partial structures of the structure of the optical element having a scattering and/or diffracting effect is chosen such that light from each lateral coherence cell of the light beam incident on the second optical arrangement is directed from the first optical arrangement approximately over the entire beam length into the substrate plane.

Since the light beam is usually shaped from a laser beam, the light beam has a predetermined lateral coherence length in the direction of the first dimension. Lateral coherence length should be understood here to be mean the distance between two partial rays which are spaced apart from one another in the first dimension, and which are indeed still capable of interference with one another. The extent of the individual lateral coherence cells in the first dimension corresponds to the lateral coherence length. In the case where light from the individual coherence cells are incident only in one or a few light channels of the first optical arrangement, this can lead to inference phenomena in the plane of the substrate. In the abovementioned configuration, by contrast, the average distance between partial structures of the optical element is chosen such that each coherence cell of the light beam illuminates the substrate homogeneously to a good approximation. Therefore, light from each coherence cell arrives at each location of the substrate and thus allows the minimization of the speckle contrast (which is of stochastic nature on account of the behavior of the individual laser modes) as a result of statistically accumulated phases.

It is furthermore preferred if an average distance of the distances between respectively adjacent partial structures of the structure of the optical element having a scattering and/or diffracting effect is chosen such that interference contrasts caused by the first optical arrangement on the substrate are minimized.

With this measure, the average distance between partial structures of the optical element is coordinated with the first optical arrangement, which, in the case of the configuration of the first optical arrangement as a fly's eye condenser, can cause interference effects which, however, can be eliminated or at least reduced by the adaptation of the average distance between the partial structures. Unlike speckle contrasts, interference contrasts are of deterministic nature and are based on the superimposition of coherent partial rays in the substrate plane.

In a further preferred configuration, the average distance of the distances between respectively adjacent partial structures satisfies the relation:

lateral coherence length l_{c} of the light beam<average distance between the partial structures.

In an even further preferred configuration, the average distance of the distances between respectively adjacent partial structures satisfies the relation:

⅓<average distance/lateral coherence length l_{c} of the light beam<5,

preferably: 1<average distance/lateral coherence length l_{c} of the light beam<3.

In a further preferred configuration, the second optical arrangement has a condenser optical unit, wherein the at least one optical element having the structure having a scattering and/or diffracting effect one-dimensionally in the first dimension produces together with the condenser optical unit a uniform illumination of the first optical arrangement.

In this case, it is advantageous that the light beam through the second optical arrangement in the interaction of the optical scattering element/diffractive optical element with the condenser optical unit has an intensity distribution in the X-dimension which has a high edge steepness.

The first optical arrangement preferably has at least one cylindrical lens array, wherein cylinder axes of the individual cylindrical lenses are oriented in the second dimension, and wherein the individual cylindrical lenses are preferably planoconvex cylindrical lenses.

In this configuration, which is known per se, the individual light channels of the first optical arrangement are formed by the individual cylindrical lenses. In contrast to the known optical system, however, the individual cylindrical lenses are illuminated significantly more fully by the upstream second optical arrangement for introducing preferably virtually the entire etendue into the system with the prehomogenized light beam.

In this case, it is furthermore preferred if, for laterally delimiting the incident light beam in the first dimension, the cylindrical lens array is in each case delimited by a wedge-shaped light-transmissive edge region, the surface of which e.g. in the second dimension is inclined relative to a plane perpendicular to the light propagation direction.

The two wedge-shaped light-transmissive regions delimit the optically usable region of the cylindrical lens array, which likewise has a positive effect on the homogeneity of the intensity distribution of the light beam in the substrate plane. As already explained above, the homogeneity of the light beam in the substrate plane is improved if only light channels of the first optical arrangement that are filled by the light as completely as possible contribute to the light beam in the plane of the substrate. The measure provided here for delimiting the light beam incident on the cylindrical lens array has the advantage over a traditional diaphragm that the heat input on account of absorption is significantly reduced. By virtue of the wedge-shaped light-transmissive edge regions, the light incident on the edge regions is deflected into the Y-dimension, for example, and can be rendered harmless in a light trap.

In a further preferred configuration, the first optical arrangement has a condenser optical unit having at least one biconcave lens.

The abovementioned cylindrical lens array(s) defining the light channels of the first optical arrangement span the light beam together with the condenser optical unit in the X-dimension in the substrate plane. The at least one provided biconcave lens in the condenser optical unit of the first optical arrangement can advantageously serve to further optimize the homogeneity of the light beam in the substrate plane in the edge region in the X-dimension. This is because the homogeneity of the light beam can assume in the substrate plane a quadratic profile, for example, which can be compensated for by corresponding bending of the biconcave lens which is correspondingly adapted to the correction of the non-constant profile of the homogeneity of the light beam. A plurality of such lenses having different bendings can be kept available, which can be introduced into the system interchangeably.

In a further preferred configuration, the optical system has a third optical arrangement, which focuses the incident light beam in the second dimension onto the substrate, wherein the third optical arrangement is constructed from mirrors.

The optical system for generating a light beam for treating a substrate is thus constructed from two subsystems, of which one subsystem shapes the light beam only in the X-dimension, in order to shape the light beam in accordance with the beam length with optimum homogeneity in the X-dimension, and wherein the other subsystem shapes the beam width of the light beam in the plane of the substrate, wherein the minimum beam width is achieved by focusing. The use of mirrors for focusing the light beam onto the substrate is advantageous with respect to a refractive arrangement with regard to the very large ratio of beam length and beam width, because a refractive arrangement causes non-linearities of the imaging on account of the dependence of the refraction on the sine of the angle of incidence or angle of reflection.

In this case, it is preferred if the third optical arrangement has at least two cylindrical mirrors, the respective cylinder axis of which runs in the first dimension, wherein a first mirror is a convex mirror and a second mirror is a concave mirror.

The advantage of this measure is that the working distance, that is to say the distance between the substrate and the last optical element upstream of the substrate, can be chosen to be large, and the imaging quality is simultaneously high. By varying the angles of incidence, mirror radii and distances, in the case of an arrangement composed of a convex mirror and a concave mirror, it is possible to set the working distance and the imaging scale within wide limits and at the same time to compensate for coma and spherical aberration. Preferably, the convex and concave mirrors follow one another directly as seen in the light propagation direction.

The abovementioned configurations of the third optical arrangement are also regarded as an independent disclosure without the characterizing portion of any claim.

In a further preferred configuration, there is present an optical element for beam delimiting in the second dimension with variable setting of a transmission region of the optical element for beam delimiting.

As already mentioned above, it is desirable, in a manner dependent on the substrate to be treated, to alter various parameters of the light beam. Thus, it is desirable from substrate to substrate, for example, to vary the beam width or the energy and/or energy density contained in the light beam. As a result of adjustable beam delimiting in the Y-dimension, the light energy acting on the substrate can be varied. If, by way of example, the transmission region of the optical element for beam delimiting is enlarged, then the energy incident on the substrate is increased. However, the enlargement of the transmission region of the optical element for beam delimiting can impair the temporal stability of the light energy and of the light energy density, as a result of which, in turn, the result of the treatment of the substrate can be impaired. This is associated with the fact that, in the case where the intensity profile of the light beam in the Y-dimension does not have high edge steepness, an albeit slight displacement of the light beam in the Y-dimension is manifested in a variation in the energy transmitted by the optical element for beam delimiting. Displacements of the light beam can be caused by fluctuations in the position of the beam path, but the intensity distribution in the light beam can also fluctuate over the process. In connection with the abovementioned measure, the configuration already mentioned above according to which the second optical arrangement can alter the beam width of the incident light beam in the second dimension by positional adjustment can then be used particularly advantageously. This is because if the transmission region of the optical element for beam delimiting is enlarged, the beam width of the incident light beam can simultaneously be enlarged by the second optical arrangement, as a result of which the intensity profile of the light beam is widened in the transmission region of the optical element for beam delimiting, such that fluctuations in the position or in the profile shape of the light beam even in the case of a large transmission region of the optical element for beam delimiting do not adversely affect the homogeneity of the light beam in the Y-dimension in the plane of the substrate. The beam delimiting element can be arranged in the third optical arrangement, but also elsewhere in the system.

Further advantages and features emerge from the following description and the accompanying drawing.

It goes without saying that the features mentioned above and those yet to be explained below can be used not only in the combination respectively specified, but also in other combinations or by themselves, without departing from the scope of the present disclosure.

### BRIEF DESCRIPTION OF THE DRAWINGS

Exemplary embodiments of the disclosure are illustrated in the drawing and are described in greater detail hereinafter with reference thereto. In the figures:

FIG. 1 shows a schematic illustration of an optical system for generating a light beam for treating a substrate, wherein the system is illustrated in the XZ plane;

FIG. 2 shows an exemplary embodiment of an optical element of the optical system in FIG. 1, wherein the optical element is illustrated in the XY plane;

FIG. 3 shows a side view in the X-direction of the optical element in FIG. 2;

FIG. 4 shows a portion of the optical system in FIG. 1 on an enlarged scale relative to FIG. 1, in an illustration in the XZ plane;

FIG. 5 shows the portion in FIG. 4 in an illustration in the YZ plane;

FIG. 6 shows a further exemplary embodiment of optical elements of the optical arrangement in FIG. 5 in an illustration in the YZ plane; and

FIG. 7 shows a basic illustration of a portion of the optical arrangement in FIG. 5, which illustrates the adaptation of the beam width to the transmission region of an optical element for the beam delimiting of the optical system in FIG. 1.

### DETAILED DESCRIPTION

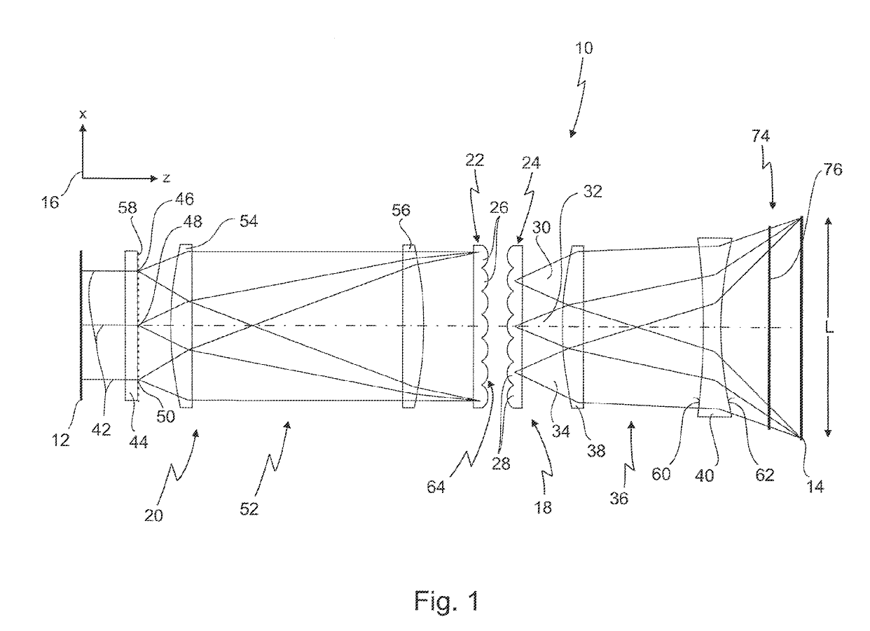

FIG. 1 schematically illustrates an optical system for generating a light beam for treating a substrate, the optical system being provided with the general reference sign 10.

The system 10 is used, in particular, in an apparatus for areally melting layers on substrates via a light beam. More specifically, the optical system 10 is used in an apparatus for crystallizing silicon layers composed of amorphous silicon for flat screen production.

The optical system 10, in such an apparatus for areally melting layers on substrates, is part of an overall optical system having, besides the optical system 10, even further optical units (not illustrated), e.g. a light source, in particular a laser, beam expanding optics, pulse multipliers and stretchers, attenuators and the like. In such an overall optical system, the optical system 10 in accordance with FIG. 1 can be, as seen in the light propagation direction, the last optically active unit in an X-dimension (which will be explained below) upstream of the substrate, as illustrated here. The system 10 is correspondingly shown, as seen in the light propagation direction, from an imaginary light entrance plane 12 of the light entrance into the optical system 10 as far as a substrate plane 14, in which a substrate (not illustrated) is situated.

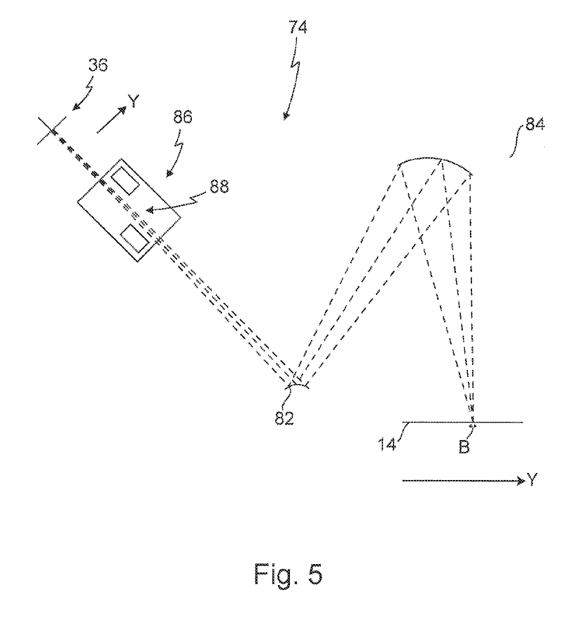

The optical system 10 is designed to generate in the substrate plane 14 a light beam having a beam length L in a first dimension, which is designated hereinafter as the X-dimension, and a beam width B (see FIG. 5) in a second dimension, which is designated hereinafter as the Y-dimension, wherein the beam length L is very much greater than the beam width B. The beam length L is more than 100 mm, e.g. approximately 300 mm, and the beam width B is less than 50 μm, in particular less than 10 μm, for example approximately 5 μm.

In FIG. 1, the light propagation direction, which runs both perpendicularly to the X-dimension and perpendicularly to the Y-dimension, is designated by Z. In FIG. 1, which shows the optical system 10 in the XZ plane, a coordinate system 16 is depicted for illustration purposes.

The optical system 10 has a first optical arrangement 18 and a second optical arrangement 20 upstream of the first optical arrangement 18 as seen in the light propagation direction.

The first optical arrangement 18 has an optical element 22 and an optical element 24. The optical element 22 defines in the X-dimension a plurality of light channels 26 which are arranged beside one another and which divide the incident light beam in the X-dimension into a plurality of partial fields. In the exemplary embodiment shown in FIG. 1, the optical element 22 defines a total of seven such light channels. However, there can be significantly more. The optical element 24 likewise defines a plurality of light channels 28 arranged alongside one another in the X-dimension, likewise seven of such light channels 28 in the exemplary embodiment in accordance with FIG. 1.

Both the optical element 22 and the optical element 24 are in each case embodied in the form of cylindrical lens arrays, wherein the respective cylinder axes of the individual cylindrical lenses extend in the Y-dimension, that is to say perpendicularly to the plane of the drawing in FIG. 1.

As is evident from FIG. 1, the individual cylindrical lenses forming the light channels 26 and 28 are in each case embodied in planoconvex fashion. In this case, the cylindrical lenses of the optical element 22 are situated with their convex light exit side opposite the convex light entrance side of the cylindrical lenses of the optical element 24.

The light channels 26 and 28 of the optical elements 22 and 24 divide the light beam incident in the optical element 22 and 24 in the X-dimension into a plurality of partial fields, and three partial fields 30, 32 and 34 are illustrated by way of example in FIG. 1.

The arrangement composed of the optical elements 22 and 24 is also designated as a (double) fly's eye condenser. Besides the fly's eye condenser, the first optical arrangement 18 also has an additional condenser optical unit 36, which has a planoconvex lens 38 and a biconcave lens 40. The first optical arrangement 18 acts on the incident light beam only in the X-dimension, while it does not or substantially does not influence the incident light beam in the Y-dimension. The lenses 38 and 40 are correspondingly embodied as cylindrical lenses whose cylinder axis runs in the Y-dimension.

The partial fields 30, 32, 34 that arise as a result of the passage of the light beam through the individual light channels 26, 28 of the first optical arrangement 18 are superimposed on one another in the X-dimension in the substrate plane 14 by the condenser optical unit 36. As a result of the dividing of the light beam incident on the first optical arrangement 18 into a plurality of partial fields arranged alongside one another in the first dimension and the superimposition of the partial fields in the first dimension in the substrate plane 14, the intensity distribution in the light beam 14 incident on the substrate plane in the X-dimension is homogenized because light from each of the light channels 26, 28 is mixed with the light from the others of the light channels 26, 28. This light mixing effected by the first optical arrangement 18 is not optimal, however, if the light channels 26, 28 are not sufficiently filled with light by the light beam incident on the individual light channels 26, 28.

In order to achieve this, the second optical arrangement 20 is provided in the optical system 10.

The second optical arrangement 20 has such an extent in the first dimension X and widens an angular spectrum of the light beam 42 incident on the second optical arrangement 18 in the first dimension X such that the etendue LLW_{X} of the second optical arrangement 20 in the first dimension X is 50% to 100% of the total etendue of the optical system 10 in the first dimension X, so that approximately all of the light channels 26, 28 of the first optical arrangement 18 are illuminated uniformly with light. Preferably, the etendue of the second optical arrangement 20 is 70% to 100%, preferably 80% to 100%, with further preference 90% to 100%, of the total etendue of the optical system 10. The second optical arrangement 20 thus introduces at least approximately the entire etendue of the optical system 10 in a single stage, as a result of which at least approximately all of the light channels 26, 28 of the first optical arrangement 18 are “filled” uniformly with light.

In the exemplary embodiment shown, this is realized by the fact that the second optical arrangement 20 has an optical element 44 having a scattering and/or diffracting effect one-dimensionally, to be precise in the X-dimension, in particular a diffractive optical element. The etendue LLWₓ at the location of the optical element 44 is given by LLWₓ=Dₓ*NAₓ, where Dₓ is the extent of the optical element 44 in the X-dimension and NAₓ is its numerical aperture. As a result of the scattering and/or diffraction of the incident light beam 42 at the optical element 44, the angular spectrum in the light beam 42 is widened such that light emerging from an arbitrary partial region of the optical element 44 along the first dimension is at least approximately incident in each light channel 26 of the optical element 22 of the first optical arrangement 18. This is illustrated in FIG. 1 for three partial regions 46, 48 and 50. The light emerging from each partial region 46, 48, 50 impinges on all the light channels 26 of the optical element 22 and thus also on all the light channels 28 of the optical element 24. Via the optical element 44, the incident light beam 42 is, in other words, reshaped such that it is incident in the first optical arrangement 18 in a prehomogenized manner. A partial region as mentioned above should be understood to mean in each case a minimal region of the optical element 44 which contains the complete angular information. Such a partial region is also designated as “pitch”.

It goes without saying that the partial regions 46, 48 and 50 shown by way of example in FIG. 1 along the X-dimension are chosen in any desired manner, that is to say that the partial regions in the X-dimension are distributed over the optical element 44. As seen over the extent of the optical element 44 in the X-dimension, the light emerging from the element 44 fills the light channels virtually completely, but at least to the extent of 80%.

The second optical arrangement 20 furthermore has a condenser optical unit 52, which directs the light beam 42 scattered and/or diffracted divergently by the optical element 44 onto the first optical arrangement 18. The condenser optical unit 52 here has two planoconvex lenses 54 and 56. The second optical arrangement 20 generates overall in the X-dimension a uniform, in particular top-hat-type, illumination of the first optical arrangement 18, that is to say that, over the extent of the first optical arrangement 20 in the X-dimension, the light beam has at the exit of the first optical arrangement 20 or at the entrance into the optical element 22 of the first optical arrangement 18 an intensity profile having an intensity plateau extending in the X-dimension over the extent of the optical element 22 with steep edges adjoining the plateau on both sides. Consequently, the first optical arrangement 18 is illuminated in its size in the X-dimension with the aperture of the optical element 44. In other words, each spatial mode of the incident light beam 42, which comes from a laser, is distributed by the second optical arrangement 20 over the entire extent of the optical element 22 of the first optical arrangement 18. In this way, the optical element 44 introduces practically the entire etendue in the X-dimension, as explained above, into the optical system 10, as a result of which the individual light channels 26, 28 of the first optical arrangement 18 are virtually completely filled or illuminated.

The optical element 44 is preferably embodied as a one-dimensional grating, in particular as a line grating. In this case, the optical element 44 has structure elements which are embodied as lines, grooves or the like and which are spaced apart differently among one another and/or have different sizes in the direction of the first dimension X. A plurality of such structure elements respectively form a partial structure 58, wherein each of the partial structures 58 represents a corresponding partial region 46, 48 or 50 from which emerging light contains the full angular information. The partial structures 58 thus form the abovementioned partial regions from which emerging light passes into each of the light channels 26, 28. The partial structures 58 extend perpendicularly to their effective direction (X-dimension) in the Y-dimension. In this case, the distance and/or the size of the individual partial structures 58 of the grating is not constant, that is to say that the partial structures 58 of the optical element 44 that are formed by the structure elements are aperiodic. This already eliminates interference modulations of the light beam emerging from the second optical arrangement 20 before entrance into the first optical arrangement 18 which could otherwise be transferred from the optical elements 22, 24 and the substantially periodic structure thereof into the substrate plane 14.

In this case, the average distance or synonymously the size in the X-dimension of the partial structures 58 of the grating is chosen such that light from each lateral coherence cell of the incident light beam 42 in the X-dimension is directed virtually over the beam length L in the X-dimension from the first optical arrangement 18 into the substrate plane 14. The average distance between the partial structures 58 of the grating is furthermore chosen with the proviso that interference contrasts which are caused by the first optical arrangement 18 and which can arise as a result of the periodic structure of the light channels 26, 28 in the substrate plane 14 are minimized.

In this case, the average distance between the partial structures 58 of the grating satisfies the relation:

lateral coherence length l_{c} of the light beam<average distance between the partial structures 58.

Preferably, the average distance of the distances between respectively adjacent partial structures satisfies the relation:

⅓<average distance between the partial structures 58/lateral coherence length l_{c} of the light beam 42<5, with further preference

1<average distance between the partial structures 58/lateral coherence length l_{c} of light beam<3.

Lateral coherence length l_{c} should be understood here to mean the distance between two partial rays of the light which are spaced apart from one another in the first dimension X and which are indeed still capable of interference with one another.

If the light beam 42 incident in the optical system 10 is pulsed, wherein, in such a case, a pulse lengthening module (not illustrated) is arranged upstream of the optical system 10, provision can be made for equipping the pulse lengthening module with offset elements, for example plates and wedges, such that successive sub-pulses enter into the optical system 10 at different locations and/or at a different angle. In this case, the location offset and/or angular offset are/is preferably chosen such that the different paths of the sub-pulses through the optical system 10 lead to different interference patterns in the substrate plane 14. Since the sub-pulses arrive in the substrate plane 14 in temporally offset fashion, they cannot infere with one another, and so a further interference contrast reduction in the substrate plane 14 is possible with these offset elements.

The optical element 44 having a scattering or diffracting effect one-dimensionally is furthermore rotatable about the Z-direction. As a result, the structure of the optical element 44 having a scattering or diffracting effect one-dimensionally can be brought from an exclusive extent in the X-dimension into a position in which the structure having an effect one-dimensionally also manifests an effect component in the Y-dimension, which can be used for increasing or correspondingly decreasing the beam width B of the light beam in the substrate plane 14, as will be described later.

In accordance with FIG. 1, the lenses 54, 56, the cylindrical lens arrays of the optical elements 22, 24 and the lens 38 are embodied in planoconvex fashion. By contrast, the lens 40 is embodied in biconcave fashion. The bending of the biconcave lens 40 is adapted to correct a non-constant profile of the homogeneity of the light beam in the substrate plane 14. A quadratic profile of the intensity of the light beam incident on the substrate plane 14 can thus be adapted or compensated for in the X-dimension. This is because, with regard to the X-dimension, the intensity of the light beam incident on the substrate plane 14 can decrease or intensify toward the edge, this reduction or intensification often assuming a quadratic profile. Via a correspondingly adapted distribution of the refractive power over the light entrance side 60 and the light exit side 62 of the lens 40 it is possible here to improve the homogeneity in the X-dimension in the edge regions.

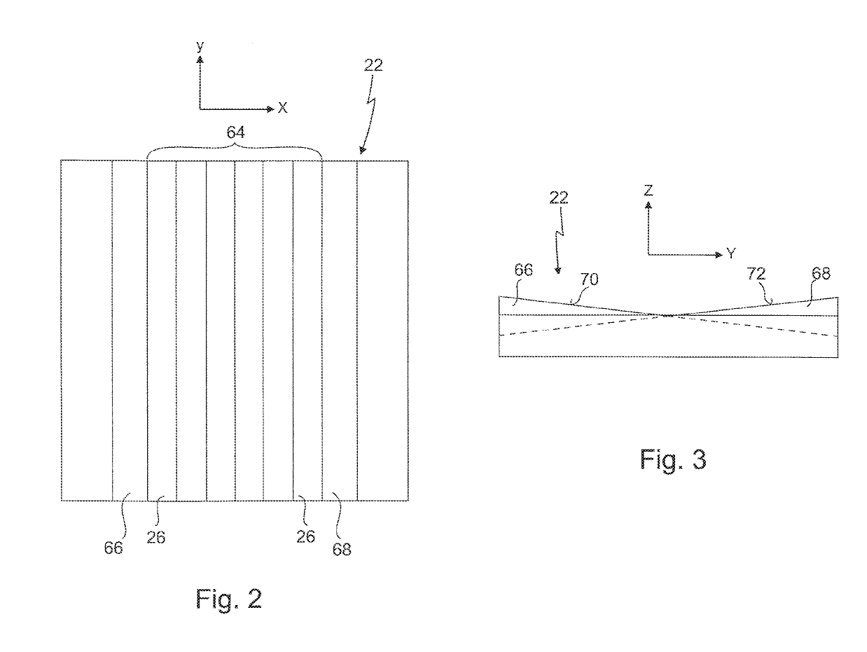

A further aspect of the optical system 10 is described with reference to FIGS. 2 and 3. FIGS. 2 and 3 show the optical element 22 in plan view in the XY plane (FIG. 2) and in the YZ plane (FIG. 3).

In FIG. 2, that region of the optical element 22 which has the cylindrical lens array is provided with the reference sign 64. FIG. 1 illustrates the optical element 22 only in the region of the cylindrical lens array 64. In accordance with FIG. 2, the region 64 is delimited on both sides in the X-dimension by a wedge-shaped light-transmissive edge region 66, 68, the respective surface 70 and 72 of which is inclined in the Y-dimension, for example. As a result, light incident on the wedge-shaped edge regions 66, 68 is deflected in the Y-direction, for example, such that light from the wedge-shaped edge regions 66 and 68 is not incident in the second optical element 24 or the cylindrical lens array of the optical element 24. The light deflected by the wedge-shaped edge regions 66 and 68 can be rendered harmless in a light trap, for example in an optical beam delimiting element in the further beam path of the optical element 10, also described below. In accordance with FIG. 3, the two wedge-shaped edge regions 66 and 68 are inclined in opposite senses with respect to one another, but the two wedge-shaped edge regions 66 and 68 can also be inclined in the same sense, and can also be parallel to one another. The beam delimiting of the light beam incident on the optical element 22 in the wedge-shaped edge regions 66 and 68 prevents the situation where one or more of the light channels 28 of the optical element 24 is or are not completely filled or uniformly illuminated, which, as has already been described above, could lead to an impaired homogeneity of the light beam in the substrate plane 14.

The previous description of the optical system 10 related to the shaping of the incident light beam 42 in the X-dimension. A description is given below of a third optical arrangement 74 of the optical system 10, which shapes the incident light beam 42 in the Y-dimension in order to focus the light beam 42 into the substrate plane 14 with the desired beam width B. In FIG. 1, the third optical arrangement 74 is illustrated in summarized fashion via a single line 76.

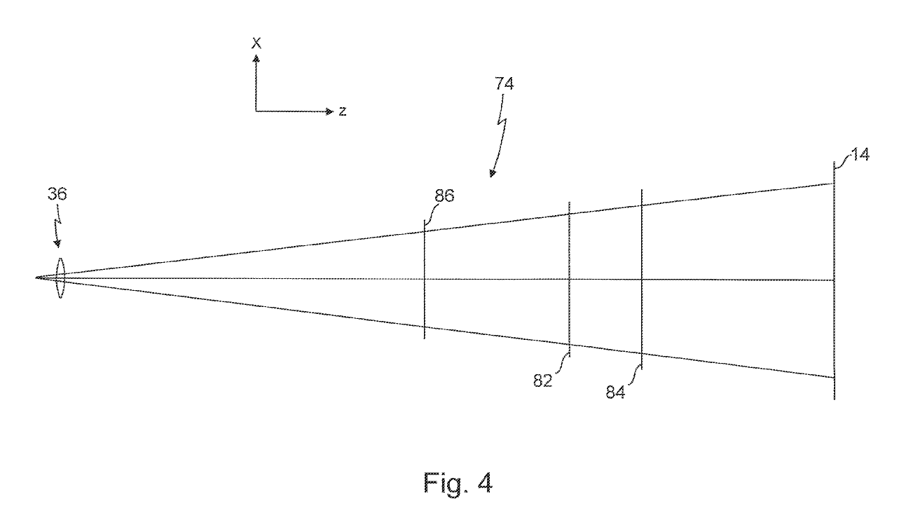

FIG. 4 shows the third optical arrangement 74 likewise as in FIG. 1 in the XZ plane, to be precise proceeding from the condenser optical unit 36 (illustrated in a simplified fashion) of the first optical arrangement 18 in FIG. 1. FIG. 5 shows the third optical arrangement 74 in the YZ plane, in which the third optical arrangement 74 is active.

The third optical arrangement 74 has reflective elements, and includes a mirror 82 and a mirror 84. In FIG. 4, the mirrors 82 and 84 are illustrated as lines since FIG. 4 is an illustration in the XZ plane, and the mirrors 82 and 84 are not active in the XZ plane.

An optical element 86 for beam delimiting in the Y-dimension is arranged upstream of the mirror 82.

The element 86 can also be arranged elsewhere in the system 10, for example also upstream of the second optical arrangement 20.

The optical element 86 has a transmission region 88 that is adjustable in a variable manner in the Y-direction. The incident light beam is directed onto the transmission region 88 of the optical element 86, and, via the mirrors 82 and 84, the transmission region 88 of the optical element 86 is imaged into the substrate plane 14 in a reduced fashion. Via the setting of the size of the transmission region 88 in the Y-dimension, it is possible to set the beam width B in the substrate plane 14, that is to say that if the beam width B in the substrate plane 14 is intended to be increased, the transmission region 88 of the optical element 86 in the Y-dimension is enlarged for this purpose.

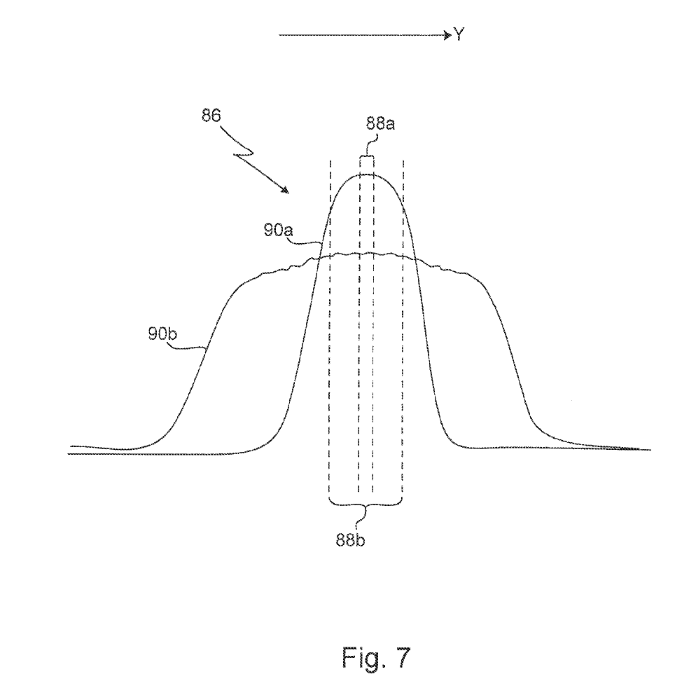

However, a controlled increase in the beam width B in the substrate plane 14 cannot just simply be achieved by enlarging the transmission region 88 of the optical element 86; rather, for this purpose, the light beam incident on the optical element 86 also has to be adapted to the enlarged transmission region 88. This is because in the Y-dimension, too, it is desirable to introduce a small portion of the etendue in the Y-dimension in a controlled manner. This is described in greater detail below with reference to FIG. 7.

FIG. 7 shows the optical element 86 for beam delimiting in the Y-dimension with two transmission regions 88a and 88b set to have different sizes.

Furthermore, FIG. 7 illustrates two beam profiles 90a and 90b of a respective light beam incident on the optical element 86.

Upon consideration of the case where the transmission region 88 of the optical element 86 is set for beam delimiting in accordance with the transmission region 88a, that is to say in narrow fashion, and if a light beam having a beam profile or intensity profile in accordance with the beam profile 90a is incident on the optical element 86, then the slight displacements of the light beam in the Y-dimension have virtually no effect on the stability of the intensity of the light beam in the substrate plane 14. By contrast, if the transmission region 88 of the optical element 86 is set to the transmission region 88b in FIG. 7, that is to say that the transmission region 88 of the optical element 86 is large, and if the same light beam having the beam profile 90a were incident on the optical element 86, then even slight displacements or fluctuations of the light beam in the Y-dimension would detrimentally affect the beam quality, in particular the temporal stability of the intensity in the Y-dimension. Therefore, in the case of the optical system 10, provision is made for adapting the beam width of the light beam incident on the optical element 86 to the size of the transmission region 88.

This is realized in the case of the optical system 10 by virtue of the fact that the optical element 44 of the second optical arrangement 20 is rotatable about the Z-direction. Upon rotation of the optical element 44 about the Z-direction, the scattering or diffracting structure 58 having an effect one-dimensionally brings about a beam widening in the Y-dimension that is adjustable in a controlled manner, because the structure elements 58 having an effect one-dimensionally now also have a component in the Y-dimension. The beam profile generated by rotating the optical element 44 is represented by the beam profile 90b in FIG. 7. As a result of the beam widening of the light beam, the beam profile 90b in the Y-dimension is formed substantially in top hat fashion with a medium intensity plateau and high edge steepness. Consequently, even in the case of the larger transmission region 88b of the optical element 86, in the substrate plane 14, fluctuations in the position of the light beam in the Y-dimension are not manifested disadvantageously with regard to the quality of the light beam and the temporal stability thereof in the substrate plane 14.

The reduction of the energy and energy density in the substrate plane 14 that is caused by the widening of the light beam can be compensated for by an increase in the energy at the light source.

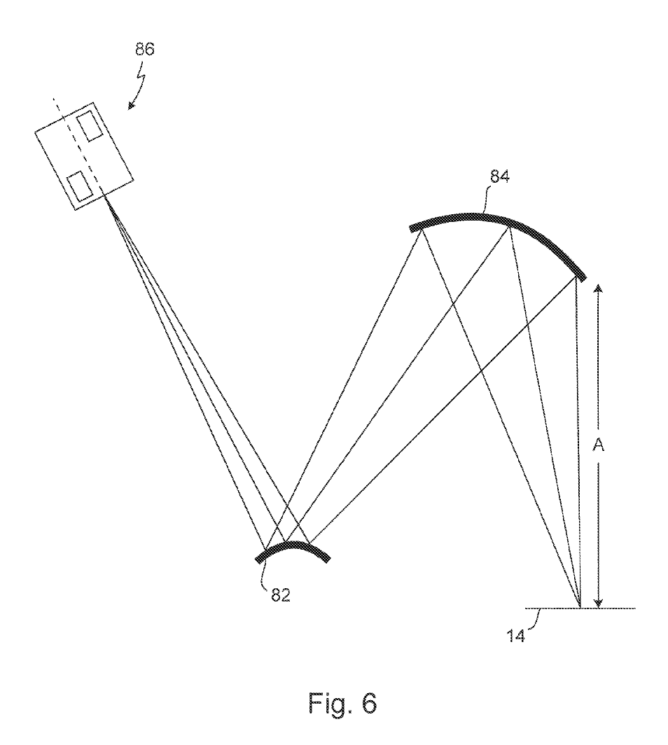

FIG. 6 illustrates yet another aspect of the optical system 10.

As already mentioned, the third optical arrangement 74 is constructed from reflective elements with regard to the focusing of the light beam in the Y-dimension into the substrate plane 14.

FIG. 6 now shows an exemplary embodiment of the third optical arrangement, wherein the mirrors 82 and 84 in accordance with FIG. 5 are both embodied as curved mirrors, wherein the mirror 82 is embodied as a convex mirror, and the mirror 84 as a concave mirror. The mirrors 82 and 84 directly follow one another.

In particular, the mirrors 82 and 84 are embodied as cylindrical mirrors whose cylinder axes extend in the direction of the X-dimension (perpendicularly to the plane of the drawing in FIG. 6). The use of at least one convex and at least one concave mirror in the third optical arrangement 74 has the advantage that the working distance A, that is to say the distance between the substrate plane 14 and the last optical element 84, can be chosen to be greater than in the case of an imaging system that at least also uses refractive elements for imaging. By varying the angles of incidence of the light beam on the mirrors 82 and 84, by varying the mirror radii and/or by varying the mirror distances, it is possible to set the working distance A and the imaging scale of the optical arrangement 74 within wide limits, and coma and spherical aberration in the imaging can also be compensated for more easily with such an arrangement than in the case of a refractive arrangement.

What is claimed is:

1. An optical system configured to generate a light beam having a propagation direction, a beam length in a first dimension perpendicular to the propagation direction, and a beam width in a second dimension perpendicular to both the first dimension and to the propagation direction, the beam length being greater than the beam width, the optical system comprising:
a first optical arrangement configured to define a plurality of light channels beside one another in the first dimension which divide the light beam in the first dimension into a plurality of partial fields, the partial fields being incident in a substrate plane in a manner superimposed on one another in the first dimension; and
a second optical arrangement upstream of the first optical arrangement in the propagation direction, the second optical arrangement having an extent in the first dimension and widening an angular spectrum of the light beam incident on the second optical arrangement in the first dimension such that an etendue of the second optical arrangement in the first dimension is 50% to 100% of a total etendue of the optical system in the first dimension so that at least approximately all of the light channels of the first optical arrangement are illuminated uniformly with light.

2. The optical system of claim 1, wherein the etendue of the second optical arrangement is 70% to 100% of the total etendue of the optical system.

3. The optical system of claim 1, wherein the second optical arrangement is configured so that light emerging from an arbitrary partial region of the second optical arrangement along the first dimension at least approximately contains the entire angular information and at least approximately enters into each light channel of the first optical arrangement.

4. The optical system of claim 1, wherein the second optical arrangement is configured to alter the beam width of the incident light beam in the second dimension via positional adjustment.

5. The optical system of claim 4, wherein the second optical arrangement is configured to alter the beam width of the incident light beam in the second dimension via rotation about the propagation direction.

6. The optical system of claim 1, wherein the second optical arrangement comprises an optical element having a structure having a scattering and/or diffracting effect one-dimensionally in the first dimension.

7. The optical system of claim 6, wherein the optical element is a diffractive optical element.

8. The optical system of claim 6, wherein the structure has structure elements that define aperiodic partial structures, each aperiodic partial structure forming one of the partial regions from which respectively emerging light at least approximately contains the entire angular information.

9. The optical system of claim 8, wherein distances between respectively adjacent partial structures are different, and/or wherein a size of the partial structures in the first dimension of the structure of the optical element is different.

10. The optical system of claim 9, wherein an average distance of the distances between respectively adjacent partial structures is configured so that light from each lateral coherence cell of the light beam incident on the second optical arrangement is directed from the first optical arrangement approximately over the entire beam length into the substrate plane.

11. The optical system of claim 9, wherein an average distance of the distances between respectively adjacent partial structures is configured to minimize interference contrasts caused by the first optical arrangement in the substrate plane.

12. The optical system of claim 11, wherein a lateral coherence length of the light of the light beam is less than the average distance between the partial structures.

13. The optical system of claim 11, wherein:
⅓<(average distance between the partial structures)/(a lateral coherence length of the light of the light beam)<5.

14. The optical system of claim 6, wherein the optical element is rotatable about an axis of the light propagation direction.

15. The optical system of claim 6, wherein the second optical arrangement comprises a condenser optical unit, and the optical element is configured to produce together with the condenser optical unit a uniform illumination of the first optical arrangement.

16. The optical system of claim 1, wherein the first optical arrangement comprises a cylindrical lens array, and cylinder axes of the individual cylindrical lenses are oriented in the second dimension.

17. The optical system of claim 16, wherein, for laterally delimiting the incident light beam in the first dimension, the cylindrical lens array is in each case delimited by a wedge-shaped light-transmissive edge region.

18. The optical system of claim 17, wherein a surface of the wedge-shaped light-transmissive edge region is inclined in the second dimension relative to a plane perpendicular to the propagation direction.

19. The optical system of claim 16, wherein the first optical arrangement comprises a condenser optical unit comprising a biconcave lens.

20. The optical system of claim 19, wherein bending of the biconcave lens is configured to correct a non-constant profile of the homogeneity of the light beam in the substrate plane.

21. The optical system of claim 1, further comprising a third optical arrangement configured to focus the incident light beam in the second dimension into the substrate plane, wherein the third optical arrangement comprises mirrors.

22. The optical system of claim 21, wherein the third optical arrangement comprises first and second cylindrical mirrors, a respective cylinder axis of which runs in the first dimension, wherein the first cylindrical mirror is a convex mirror, and the second cylindrical mirror is a concave mirror.

23. The optical system of claim 1, comprising an optical element configured to delimit the second dimension with variable setting of a transmission range of the optical element for beam delimiting.
